(19) United States
(12) Patent Application Publication
(10) Pub. No.: US 2026/0208095 A1
(43) Pub. Date: Jul. 23, 2026

(54) SOLVENT RECOVERY APPARATUS

(71) Applicant: Taikisha Ltd., Tokyo (JP)

(72) Inventors: Munenori OGUCHI, Tokyo (JP); Keisuke KODERA, Tokyo (JP); Yukinobu KITADA, Tokyo (JP)

(21) Appl. No.: 19/342,406

(22) Filed: Sep. 26, 2025

(30) Foreign Application Priority Data
Oct. 1, 2024 (JP) 2024-172586
Jul. 29, 2025 (JP) 2025-126375

(51) Int. Cl. B01D 53/08

(52) U.S. Cl. CPC B01D 53/08; B01D 2257/704; B01D 2259/40003; B01D 2259/40009

(57) ABSTRACT

There is provided a solvent recovery apparatus including: a cooling recovery device to which an untreated gas is supplied and which cools and condenses a solvent vapor contained in the untreated gas; an adsorption concentrator to which a primary-treated gas obtained by cooling and condensing the solvent vapor of the untreated gas in the cooling recovery device is supplied; an adsorption rotor that is provided in the adsorption concentrator and has an adsorption region in which uncondensed solvent vapor contained in the primary-treated gas is adsorbed and a desorption region in which a solvent vapor adsorbed in the adsorption region is desorbed; a desorption gas supply channel through which the untreated gas is supplied to the desorption region; and a desorption gas discharge channel through which a concentrated gas containing a solvent vapor desorbed from the desorption region is discharged to the cooling recovery device.

### CROSS-REFERENCE TO RELATED APPLICATION

This application claims priority under 35 USC 119 from Japanese Patent Applications No. 2024-172586, filed on Oct. 1, 2024, and No. 2025-126375, filed on Jul. 29, 2025, the disclosure of which is incorporated by reference herein.

### BACKGROUND

### Technical Field

The present disclosure relates to a solvent recovery apparatus that condenses and recovers a volatile solvent by a cooling recovery device.

### Related Art

Japanese Patent Application Laid-Open (JP-A) No. 2014-87746 discloses a solvent recovery facility, and the solvent recovery facility does not need to include a cooler which cools a treatment target gas by using cooling water.

### SUMMARY

An object is to reduce energy required for heating a desorption gas for desorbing a solvent from an adsorbent to which the solvent has been adsorbed in a solvent recovery apparatus that condenses and recovers a volatile solvent by a cooling recovery device.

A solvent recovery apparatus according to one aspect of the disclosure includes: a cooling recovery device which cools and condenses a solvent vapor contained in an untreated gas; an adsorption concentrator to which a primary-treated gas obtained by cooling and condensing the solvent vapor of the untreated gas in the cooling recovery device is supplied; an adsorption rotor that is provided in the adsorption concentrator and has an adsorption region in which uncondensed solvent vapor contained in the primary-treated gas is adsorbed and a desorption region in which solvent vapor adsorbed in the adsorption region is desorbed; a desorption gas supply channel through which the untreated gas is supplied to the desorption region; and a desorption gas discharge channel through which a concentrated gas containing solvent vapor desorbed from the desorption region is discharged to the cooling recovery device.

According to this aspect, since a part of the untreated gas derived from a production process is used as a desorption gas, it is not necessary to heat the desorption gas.

According to the disclosure, in the solvent recovery apparatus that condenses and recovers a volatile solvent by the cooling recovery device, it is possible to reduce energy required for heating the desorption gas for desorbing a solvent from an adsorbent to which the solvent has been adsorbed.

### BRIEF DESCRIPTION OF THE DRAWINGS

Exemplary embodiments will be described in detail based on the following figures, wherein:

FIG. 1 is a schematic diagram showing an outlined configuration of a solvent recovery apparatus according to a first embodiment;

FIG. 2 is a schematic diagram showing a modification example of the first embodiment;

FIG. 3 is a schematic diagram showing an outlined configuration of a solvent recovery apparatus according to a second embodiment;

FIG. 4 is a schematic diagram showing a modification example of the second embodiment;

FIG. 5 is a schematic diagram showing an outlined configuration of a solvent recovery apparatus according to a third embodiment;

FIG. 6 is a block diagram showing a hardware configuration of a control unit;

FIG. 7 is a flowchart for describing a function of the control unit; and

FIG. 8 is a schematic diagram showing a modification example of the third embodiment.

### DETAILED DESCRIPTION

Hereinafter, an example of a mode for carrying out a technology of the disclosure will be described in detail with reference to the drawings. Note that, configurational elements and processes fulfilling similar operations, effects, and functions are denoted by the same reference numerals throughout the drawings, and redundant description thereof may be omitted, as appropriate. The drawings are only schematically shown to the extent that the technology of the disclosure can be sufficiently understood. Therefore, the technology of the disclosure is not limited only to the illustrated example. Moreover, in this embodiment, description of a configuration that is not directly related to the technology of the disclosure or a well-known configuration may be omitted.

### (1) First Embodiment

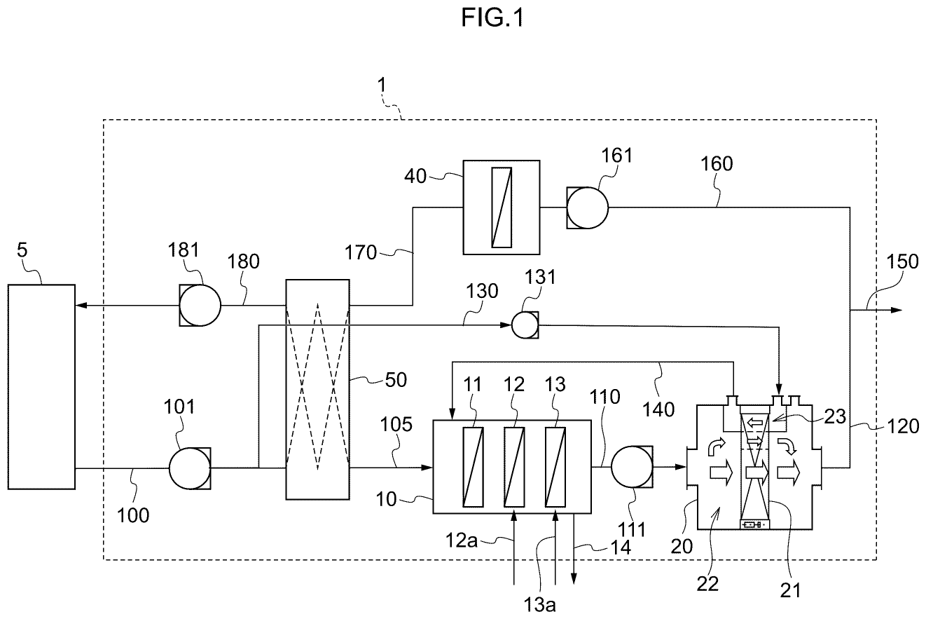

FIG. 1 is a schematic diagram showing an outlined configuration of a solvent recovery apparatus 1 according to a first embodiment. The solvent recovery apparatus 1 according to the present embodiment includes: a raw discharge gas channel 100 through which an untreated gas containing a solvent vapor is discharged, the untreated gas being produced in a production process 5; a cooling recovery device 10 to which the untreated gas is supplied from the raw discharge gas channel 100 and which cools and condenses the solvent vapor contained in the untreated gas; a primary discharge channel 110 through which a primary-treated gas obtained by cooling and condensing the solvent vapor of the untreated gas in the cooling recovery device 10 is discharged; an adsorption concentrator 20 to which the primary-treated gas is supplied from the primary discharge channel 110; an adsorption rotor 21 that is provided in the adsorption concentrator 20 and adsorbs uncondensed solvent vapor contained in the primary-treated gas; an adsorption region 22 that is disposed inside the adsorption concentrator 20 and in which an adsorption treatment of a solvent vapor is performed by circulating the primary-treated gas through the adsorption rotor 21; a desorption region 23 which is divided from the adsorption region 22 inside the adsorption concentrator 20 and in which a solvent vapor adsorbed in the adsorption region 22 is heated and desorbed with a desorption gas having a temperature higher than that of the primary-treated gas; a secondary discharge channel 120 through which a secondary-treated gas obtained by performing an adsorption treatment on the primary-treated gas in the adsorption region 22 is discharged; a desorption gas supply channel 130 which branches from the raw discharge gas channel 100 and through which a part of the untreated gas is supplied as the desorption gas to the desorption region 23; and a desorption gas discharge channel 140 through which a concentrated gas containing a solvent vapor desorbed from the adsorption rotor 21 with the desorption gas in the desorption region 23 is discharged to the cooling recovery device 10.

That is, the solvent recovery apparatus 1 of the present embodiment includes: a cooling recovery device 10 to which an untreated gas is supplied and which cools and condenses a solvent vapor contained in the untreated gas; an adsorption concentrator 20 to which a primary-treated gas obtained by cooling and condensing the solvent vapor of the untreated gas in the cooling recovery device 10 is supplied; an adsorption rotor 21 that is provided in the adsorption concentrator 20 and has an adsorption region 22 in which uncondensed solvent vapor contained in the primary-treated gas is adsorbed and a desorption region 23 in which solvent vapor adsorbed in the adsorption region 22 is desorbed; a desorption gas supply channel 130 through which the untreated gas is supplied to the desorption region 23; and a desorption gas discharge channel 140 through which a concentrated gas containing a solvent vapor desorbed from the desorption region 23 is discharged to the cooling recovery device 10.

Moreover, the solvent recovery apparatus 1 of the present embodiment further includes a heat exchanger 50 that performs heat exchange between the untreated gas having a higher temperature in the raw discharge gas channel 100 and the secondary-treated gas having a lower temperature in the secondary discharge channel 120. That is, the solvent recovery apparatus 1 of the present embodiment further includes the heat exchanger 50 that performs heat exchange between the untreated gas that is supplied to the cooling recovery device 10 and the secondary-treated gas.

The untreated gas containing a solvent vapor produced in the production process 5 is supplied to the cooling recovery device 10 through the raw discharge gas channel 100 and a cooling supply channel 105 by a raw discharge gas blower fan 101. The desorption gas supply channel 130 branches from the raw discharge gas channel 100, and a part of the untreated gas is supplied as the desorption gas through the desorption gas supply channel 130 to the adsorption concentrator 20. This will be described below. The untreated gas supplied from the raw discharge gas channel 100 to the cooling recovery device 10 is cooled with the secondary-treated gas flowing in the secondary heating channel 170 to be described below via the heat exchanger 50. The cooled untreated gas is supplied to the cooling recovery device 10 through the cooling supply channel 105. A concentrated gas containing solvent vapor at a relatively high concentration is also supplied to the cooling recovery device 10 through a desorption gas discharge channel 140 from the adsorption concentrator 20 to be described below.

In the cooling recovery device 10, the untreated gas supplied from the raw discharge gas channel 100 is cooled by a built-in precooler 11, a built-in primary cooler 12, and a built-in secondary cooler 13. The precooler 11 supplies cooling energy by circulating a refrigerant between the precooler and a supply preheater 40 to be described below. The cooling energy is supplied to the primary cooler 12 and the secondary cooler 13 via a primary refrigerant flow channel 12a and a secondary refrigerant flow channel 13a, respectively, by circulating the refrigerant between the precooler and an external heat source. As the untreated gas is cooled inside the cooling recovery device 10, the contained solvent vapor is condensed and liquefied and is recovered as a liquid organic solvent from a solvent recovery channel 14.

The untreated gas from which the solvent vapor is recovered by the cooling recovery device 10 and a concentrated gas to be described below become primary-treated gases and are supplied through the primary discharge channel 110 to the adsorption concentrator 20 by a primary discharge blower fan 111. In the adsorption concentrator 20, the built-in disk-shaped adsorption rotor 21 including a structure having an adsorbent-supported ventilation gap is provided. The adsorption rotor 21 is provided perpendicular to a flow channel direction of the primary-treated gas inside the adsorption concentrator 20. The inside of the adsorption concentrator 20 is divided into two isolated regions of the adsorption region 22 having a relatively large volume and the desorption region 23 having a relatively small volume. While the adsorption rotor 21 rotates around an axial center inside the adsorption concentrator 20, a solvent vapor remaining in the primary-treated gas having a relatively low temperature in the adsorption region 22 is adsorbed by the adsorption rotor 21, and a solvent vapor adsorbed in the desorption region 23 is heated and desorbed from the adsorption rotor 21 with the desorption gas having a temperature higher than that of the primary-treated gas.

While the untreated gas maintains a high temperature state through the desorption gas supply channel 130 which branches from the raw discharge gas channel 100, the untreated gas is supplied as the desorption gas to the desorption region 23 of the adsorption concentrator 20 by a desorption blower fan 131 without passing through the heat exchanger 50. In the desorption region, the adsorption rotor 21 is exposed to the desorption gas having a high temperature, and the adsorbed solvent vapor is desorbed and is mixed with the desorption gas, so that the solvent vapor becomes a concentrated gas having a higher concentration. As described above, the concentrated gas is supplied to the cooling recovery device 10 through the desorption gas discharge channel 140, and the contained solvent vapor is recovered as a liquid organic solvent. The desorption gas herein contains the solvent vapor at a relatively high concentration, but the desorption gas does not reach a saturated state. Hence, the desorption gas can further contain the desorbed solvent vapor. Moreover, it is necessary to increase the temperature of the desorption gas in order to desorb the solvent vapor from the adsorption rotor 21, but in the present embodiment, since the originally high-temperature untreated gas is used almost as is as the desorption gas, it is not necessary to heat the desorption gas, and the energy required for heating can be reduced.

The primary-treated gas is subjected to adsorption concentration of the solvent vapor by the adsorption concentrator 20 and is discharged as a secondary-treated gas having a significantly reduced solvent vapor concentration from the secondary discharge channel 120 on the downstream side. A part of the secondary-treated gas is released outside from a release channel 150. The secondary-treated gas that is not released outside from the release channel 150 is sent through a primary heating channel 160 to the supply preheater 40 by a heating blower fan 161 and is heated. The supply preheater 40 heats the secondary-treated gas with heat supplied from the precooler 11 while cooling energy is supplied to the precooler 11 of the cooling recovery device 10 described above. The heated secondary-treated gas is heated by heat exchange with the raw discharge gas flowing in the raw discharge gas channel 100 described above by further passing through the secondary heating channel 170 and via the heat exchanger 50. The secondary-treated gas is heated by the heat exchanger 50 and sent through a supply channel 180 to the production process 5.

For example, N-methylpyrrolidone is generated as the solvent vapor in the production process 5 in a lithium ion battery manufacturing plant. In this case, a temperature of a gas and a solvent concentration in each flow channel in FIG. 1 are, for example, as shown in Table 1 below.

TABLE 1

| | | Solvent |
|---|---|---|
| | Temperature | concentration |
| Flow channels | (° C.) | (ppm) |
| Raw discharge gas channel 100 | 120 | 2,000 |
| Cooling supply channel 105 | 70 | 2,000 |
| Desorption gas supply channel 130 | 100 | 2,000 |
| Desorption gas discharge channel 140 | 60 | 2,600 |
| Primary discharge channel 110 | 12 | 200 |
| Secondary discharge channel 120 to | 15 | 10 |
| primary heating channel 160 | | |
| Secondary heating channel 170 | 50 | 10 |
| Supply channel 180 | 90 | 10 |

In the raw discharge gas channel 100, a raw discharge gas having a solvent concentration of 2,000 ppm at a temperature of 120° C. is cooled to a temperature of 70° C. through the heat exchanger 50 and reaches the cooling recovery device through the cooling supply channel 105. On the other hand, a desorption gas having a solvent concentration of 2,000 ppm at a temperature of 100° C. in the desorption gas supply channel 130 which branches from the raw discharge gas channel 100 passes through the desorption region 23 of the adsorption concentrator 20, becomes a concentrated gas having a solvent concentration of 2,600 ppm at a temperature of 60° C., and reaches the cooling recovery device 10 via the desorption gas discharge channel 140. The cooled raw discharge gas and the concentrated gas are cooled through the cooling recovery device 10 to a temperature of 12° C., become the primary-treated gas having a solvent concentration reduced to 200 ppm, and reach the primary discharge channel 110.

The primary-treated gas passes through the adsorption concentrator 20, becomes the secondary-treated gas in a state in which the solvent concentration is reduced to 10 ppm at a temperature of 15° C., is heated to 45° C. by the supply preheater 40, is further heated to 90° C. by the heat exchanger 50, and is again supplied to the production process 5.

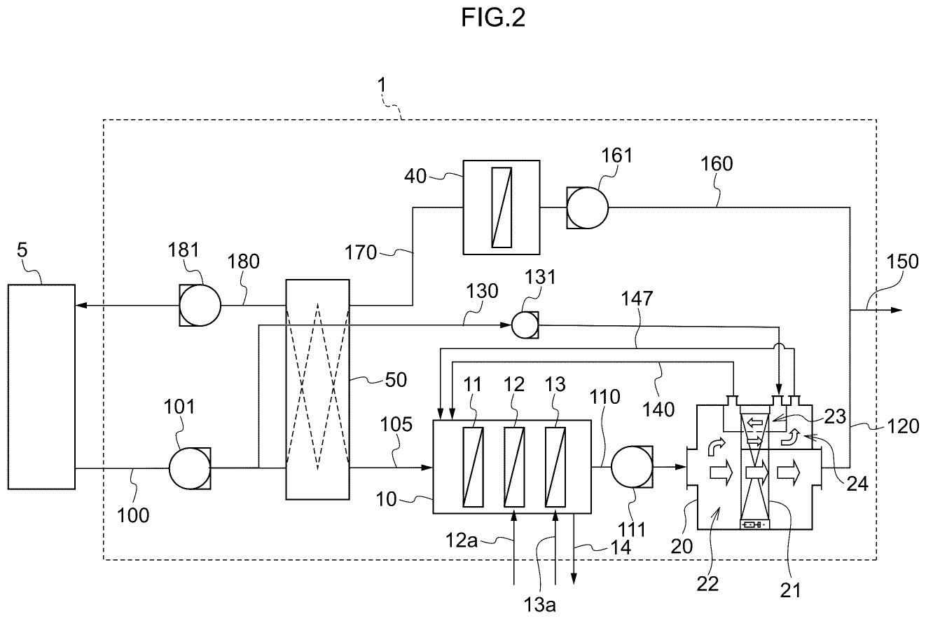

Note that, in the present embodiment, as shown in a modification example of FIG. 2, a cooling region 24 divided from the desorption region 23 and the adsorption region 22 may be set between the desorption region 23 and the adsorption region 22 inside the adsorption concentrator 20. In the cooling region 24, the adsorption rotor 21 heated by the desorption region 23 is cooled with a part of the cooled primary-treated gas supplied from the primary discharge channel 110, so that the adsorption of the solvent vapor in the adsorption region 22 is performed again. The primary-treated gas that has cooled the adsorption rotor 21 in the cooling region 24 is again supplied from the adsorption concentrator 20 via the cooling circulation channel 147 to the cooling recovery device 10. That is, the adsorption rotor 21 may further have the cooling region 24 that is disposed between the desorption region 23 and the adsorption region 22 and to which the primary-treated gas is supplied.

### (2) Second Embodiment

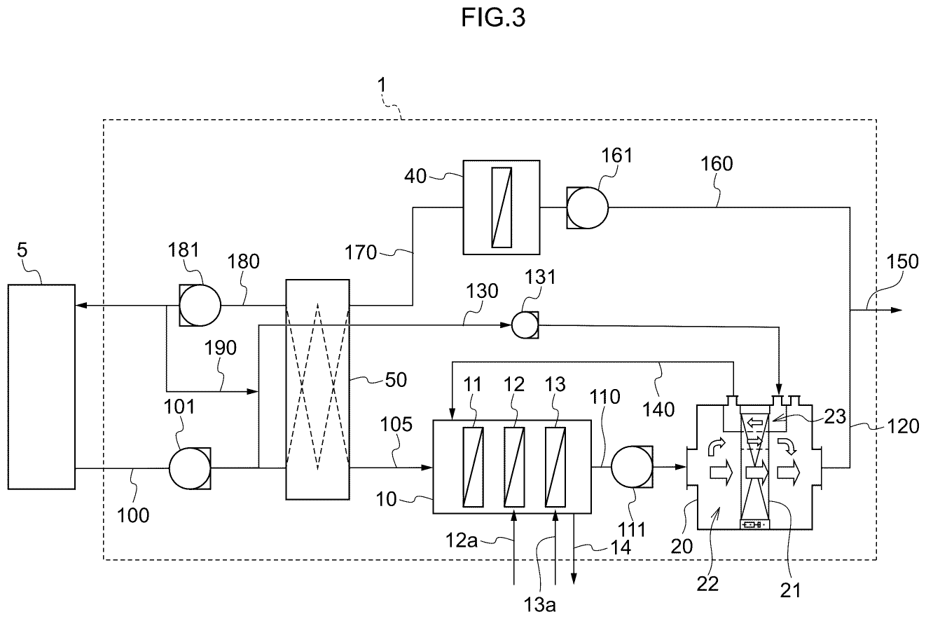

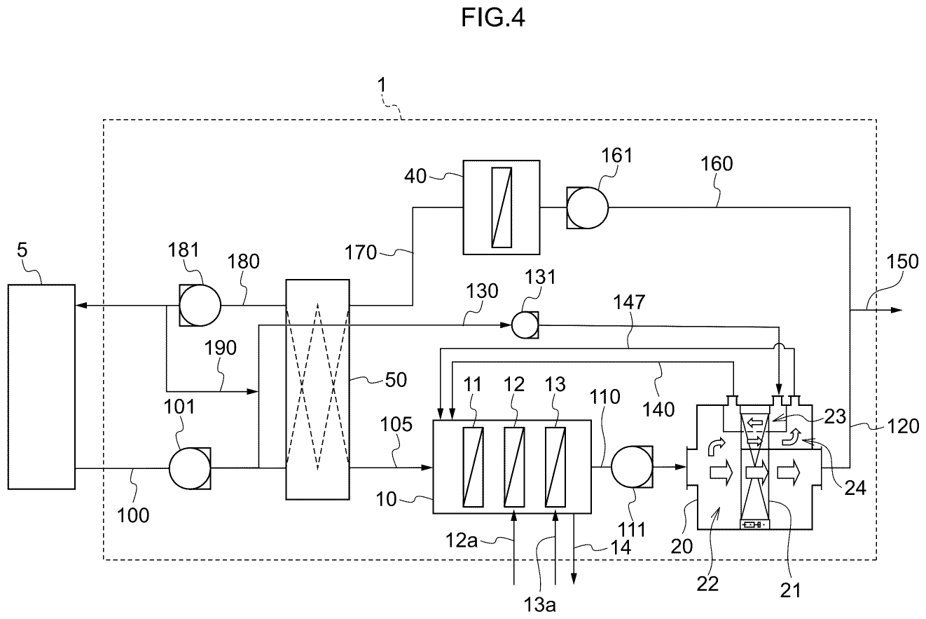

FIG. 3 is a schematic diagram showing an outlined configuration of a solvent recovery apparatus 1 according to a second embodiment. In addition to the configuration of the solvent recovery apparatus 1 of the first embodiment, the solvent recovery apparatus 1 of the present embodiment further includes a circulation gas supply channel 190 that branches from a downstream portion of the secondary discharge channel 120 and joins the desorption gas supply channel 130. The secondary-treated gas from the circulation gas supply channel 190 is mixed with the untreated gas of the desorption gas supply channel 130, so that solvent concentrations of the desorption gas and the concentrated gas can be reduced. Note that, also in the present embodiment, as shown in a modification example of FIG. 4, the cooling region 24 divided from the desorption region 23 and the adsorption region 22 may be set between the desorption region 23 and the adsorption region 22 inside the adsorption concentrator 20. A structure and significance of the cooling region 24 are the same as those in the first embodiment described above. That is, the solvent recovery apparatus 1 of the present embodiment further includes the circulation gas supply channel 190 through which the secondary-treated gas resulting from an adsorption treatment of the primary-treated gas in the adsorption region 22 is supplied to the desorption gas supply channel 130.

### (3) Third Embodiment

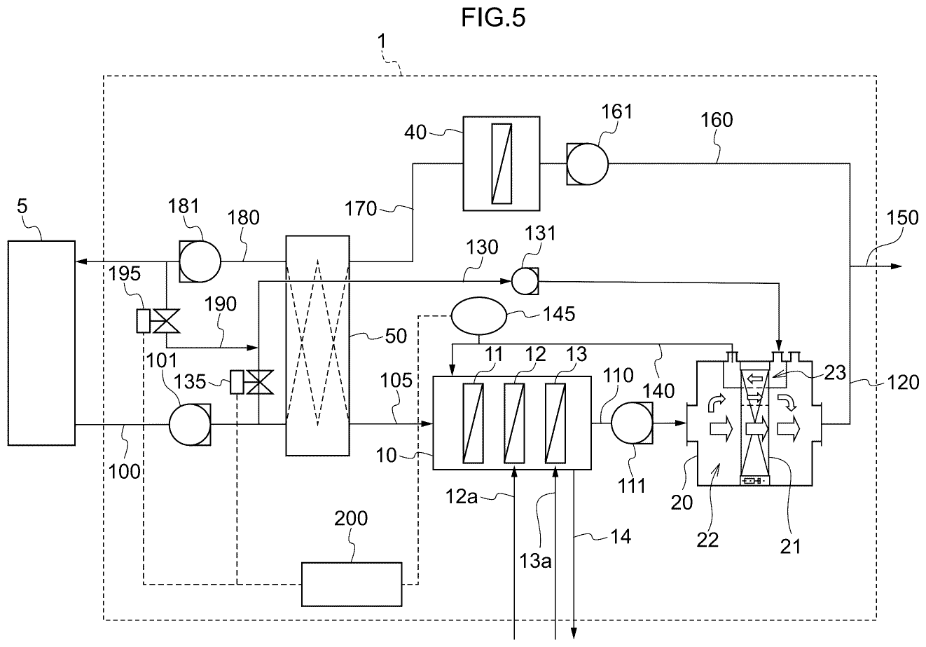

FIG. 5 is a schematic diagram showing an outlined configuration of a solvent recovery apparatus 1 according to a third embodiment. The solvent recovery apparatus 1 of the present embodiment further includes: in addition to the configuration of the solvent recovery apparatus 1 of the second embodiment, a concentration sensor 145 that measures a concentration of solvent vapor contained in the concentrated gas of the desorption gas discharge channel 140; a desorption gas supply valve 135 that opens and closes the desorption gas supply channel 130; a circulation gas supply valve 195 that opens and closes the circulation gas supply channel 190; and a control unit 200 that controls opening and closing of the desorption gas supply valve 135 and the circulation gas supply valve 195 depending on the concentration measured by the concentration sensor 145. That is, the solvent recovery apparatus 1 of the present embodiment further includes: the concentration sensor 145 that measures the concentration of the solvent vapor in the desorption gas discharge channel 140; the desorption gas supply valve 135 that opens and closes the desorption gas supply channel 130; the circulation gas supply valve 195 that opens and closes the circulation gas supply channel 190; and the control unit 200 that controls opening and closing of the desorption gas supply valve 135 and the circulation gas supply valve 195 depending on the concentration measured by the concentration sensor 145.

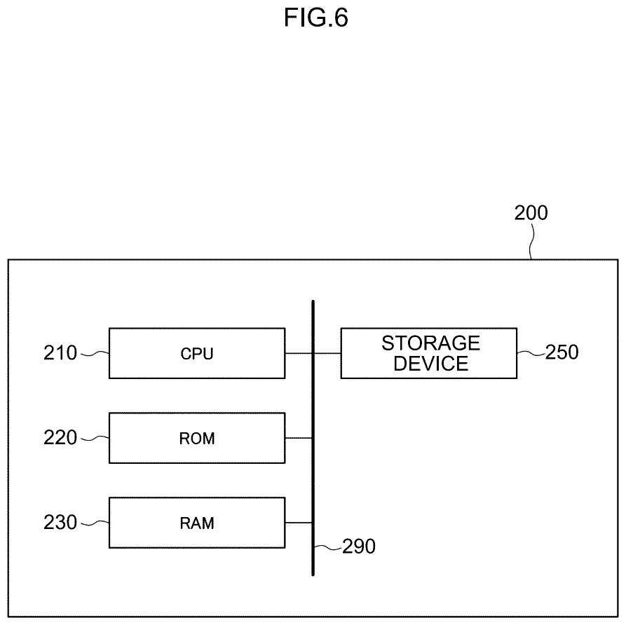

As shown in a hardware configuration of FIG. 6, the control unit 200 includes a central processing unit (CPU) 210, a read only memory (ROM) 220, a random access memory (RAM) 230, and a storage device 250. Configurations thereof are communicatively connected to each other via a bus 290.

The CPU 210 that is a central processing unit executes various programs that can be realized as an installed application and controls each unit. That is, the CPU 210 reads a program from the ROM 220 or the storage device 250 or executes the program by using the RAM 230 as a work area. The CPU 210 opens and closes the desorption gas supply valve 135 and the circulation gas supply valve 195 according to a program recorded in the ROM 220 or the storage device 250.

The ROM 220 stores various programs and various items of data. The RAM 230 temporarily stores a program or data as a work area. The storage device 250 is configured as a storage including a hard disk drive (HDD), a solid state drive (SSD), or a flash memory and stores various programs including an operating system and various items of data.

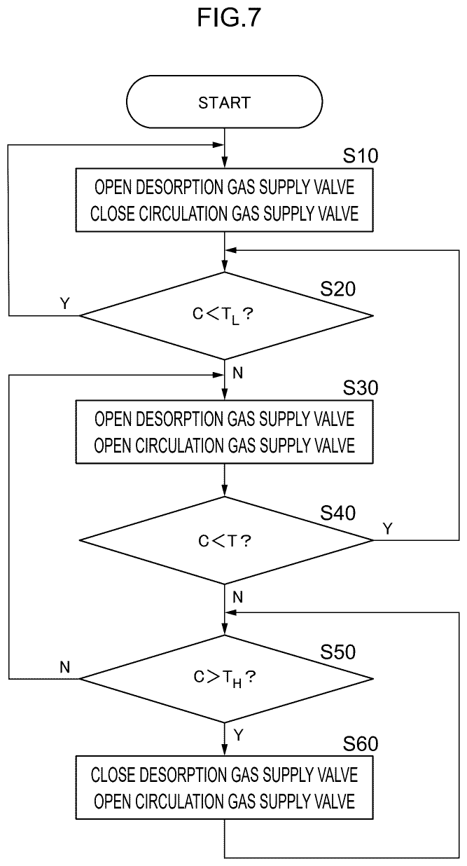

A specific example of a function of the control unit 200 will be described with reference to the flowchart of FIG. 7. Note that, in this example, a set value of the solvent concentration (C) in the desorption gas discharge channel 140 is represented by T, and a lower limit value and an upper limit value of a set range of the solvent concentration with T as a median is represented by TL and TH, respectively. When the solvent recovery apparatus 1 is operated, the control unit 200 first opens the desorption gas supply valve 135 and closes the circulation gas supply valve 195 at a step represented by S10. Then, in a step represented by S20, while it is determined that the solvent concentration (C) measured by the concentration sensor 145 does not reach the lower limit value (TL), the control unit 200 maintains an open state of the desorption gas supply valve 135 and a closed state of the circulation gas supply valve 195.

On the other hand, when it is determined that the solvent concentration (C) measured by the concentration sensor 145 is equal to or higher than the lower limit value (TL) in the step represented by S20, the control unit 200 opens the circulation gas supply valve 195 as well as the desorption gas supply valve 135 in a step represented by S30. This causes the secondary-treated gas to be mixed with the untreated gas in the desorption gas supply channel 130, and the solvent concentration is reduced in the desorption gas supply channel 130.

Next, in a step represented by S40, the control unit 200 determines whether the solvent concentration (C) measured by the concentration sensor 145 reaches the set value (T). When control unit determines that the solvent concentration (C) does not reach the set value (T), the control unit 200 again determines whether the solvent concentration (C) measured by the concentration sensor 145 reaches the lower limit value (TL) in the step represented by S20.

On the other hand, when the control unit 200 determines that the solvent concentration (C) measured by the concentration sensor 145 is equal to or higher than the set value (T) in the step represented by S40, the control unit 200 determines whether the solvent concentration (C) exceeds the upper limit value (TH) in a step represented by S50. When the control unit 200 determines that the solvent concentration (C) is equal to or lower than the upper limit value (TH), the open state of both the desorption gas supply valve and the circulation gas supply valve 195 in the step represented by S30 is maintained.

On the other hand, when the control unit 200 determines that the solvent concentration (C) measured by the concentration sensor 145 exceeds the upper limit value (TH) in the step represented by S50, the control unit 200 closes the desorption gas supply valve 135 and opens the circulation gas supply valve 195 in a step represented by S60. This causes the supply of the untreated gas to the desorption gas supply channel 130 to be cut off, and only the secondary-treated gas is supplied through the desorption gas supply channel 130 to the adsorption concentrator 20. Then, in the step represented by S50, the closed state of the desorption gas supply valve 135 and the open state of the circulation gas supply valve 195 in the step represented by S60 are maintained unless the solvent concentration (C) measured by the concentration sensor 145 becomes equal to or lower than the upper limit value (TH).

Thereby, control is performed such that the solvent concentration of the concentrated gas in the desorption gas discharge channel 140 which is measured by the concentration sensor 145 is maintained within a range between the lower limit value (TL) and the upper limit value (TH) with the set value (T) as the median.

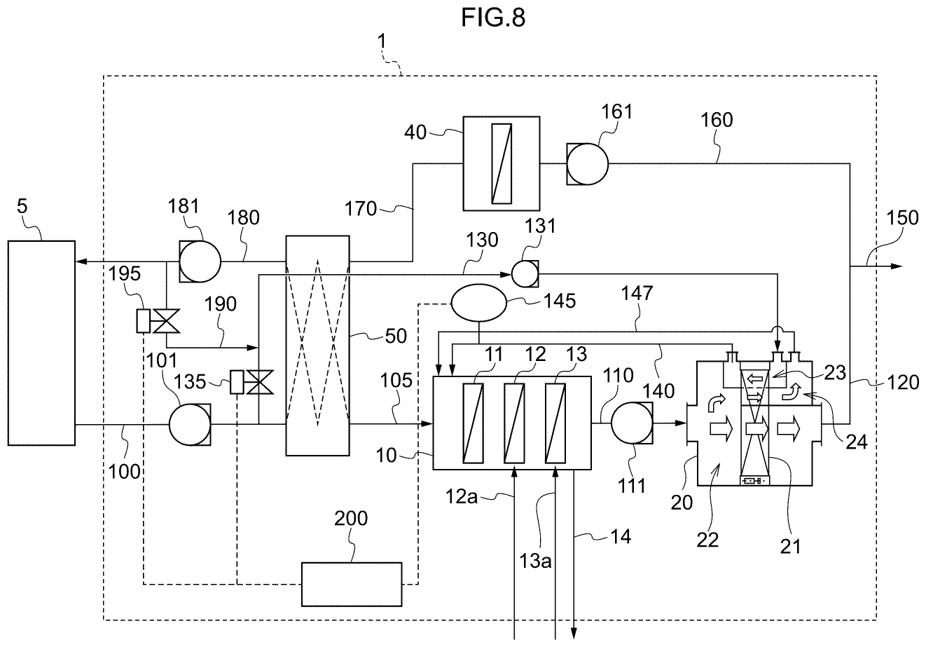

Note that, also in the present embodiment, as shown in a modification example of FIG. 8, the cooling region 24 divided from the desorption region 23 and the adsorption region 22 may be set between the desorption region 23 and the adsorption region 22 inside the adsorption concentrator 20. The structure and significance of the cooling region 24 are the same as those in the first embodiment described above.

What is claimed is:

1. A solvent recovery apparatus comprising:
a cooling recovery device to which an untreated gas is supplied and which cools and condenses a solvent vapor contained in the untreated gas;
an adsorption concentrator to which a primary-treated gas obtained by cooling and condensing the solvent vapor of the untreated gas in the cooling recovery device is supplied;
an adsorption rotor that is provided in the adsorption concentrator and has an adsorption region in which uncondensed solvent vapor contained in the primary-treated gas is adsorbed and a desorption region in which solvent vapor adsorbed in the adsorption region is desorbed;
a desorption gas supply channel through which the untreated gas is supplied to the desorption region; and
a desorption gas discharge channel through which a concentrated gas containing solvent vapor desorbed from the desorption region is discharged to the cooling recovery device.

2. The solvent recovery apparatus according to claim 1, further comprising a circulation gas supply channel through which a secondary-treated gas resulting from an adsorption treatment of the primary-treated gas in the adsorption region is supplied to the desorption gas supply channel.

3. The solvent recovery apparatus according to claim 2, further comprising:
a concentration sensor that measures a concentration of solvent vapor in the desorption gas discharge channel;
a desorption gas supply valve that opens and closes the desorption gas supply channel;
a circulation gas supply valve that opens and closes the circulation gas supply channel; and
a control unit that controls opening and closing of the desorption gas supply valve and the circulation gas supply valve depending on the concentration measured by the concentration sensor.

4. The solvent recovery apparatus according to claim 2, further comprising a heat exchanger that performs heat exchange between the untreated gas that is supplied to the cooling recovery device and the secondary-treated gas.

5. The solvent recovery apparatus according to claim 1, wherein the adsorption rotor further has a cooling region that is disposed between the desorption region and the adsorption region and to which the primary-treated gas is supplied.
